(19) United States
(12) Patent Application Publication
(10) Pub. No.: US 2026/0023631 A1
(43) Pub. Date: Jan. 22, 2026

(54) OPTIMAL ANTHROPOMORPHIC COMPUTING EQUIPMENT INSPECTION SYSTEM

(71) Applicant: BiaTech Corporation, Tampa, FL (US)

(72) Inventor: Nathaniel HARTWIG, Tampa, FL (US)

(21) Appl. No.: 19/275,368

(22) Filed: Jul. 21, 2025

Related U.S. Application Data
(60) Provisional application No. 63/673,498, filed on Jul. 19, 2024.

(51) Int. Cl. G06F 11/00

(52) U.S. Cl. CPC G06F 11/004; G06F 2201/805

(57) ABSTRACT

The disclosure principles provide a system and method for inspecting equipment. The system includes a plurality of sensors to collect equipment data. The sensors include but are not limited to cameras, microphones, and thermal sensors. The system also includes a computing device with an artificial intelligence-enabled program configured to analyze collected data and generate a multimodal output. The computing device is supported by a central cloud platform for multi-system learning. The multimodal output includes visual, auditory, tactile, olfactory, and gustatory stimuli. The system also includes a user interface configured to present the multimodal output to at least one user and collect user input data for storage, analysis, and future artificial intelligence improvement. The continuous improvement system is advantaged from human-in-the-loop learning processes improving artificial intelligence that further improves the equipment inspection process.

### CROSS-REFERENCE TO RELATED APPLICATIONS

The present application is related to U.S. Provisional Patent Application 63/673,498 filed Jul. 19, 2024, entitled “System for Analysis of Real-Time Data at the Sensor Edge of an Industrial Facility”. The present application hereby claims priority under 35 U.S.C. § 119(e) to U.S. Provisional Patent Application No. 63/673,498. The above-identified provisional patent application is hereby incorporated by reference in its entirety.

### TECHNICAL FIELD

The present disclosure relates in general to the field of physical asset management, and more particularly to a novel equipment inspection system and method for precise equipment data collection, analysis, and presentation.

### BACKGROUND

To ensure safe, efficient operation of industrial equipment, frequent inspections of equipment are required. Critical equipment is often regulated using certified inspectors or formally trained workers. Traditional methods of equipment inspection primarily rely on manual visual inspections to assess equipment operation and detect equipment damage or manual measurement covering a fraction of the total area to be inspected. These methods are often inconsistent, subjective, and inefficient and cannot provide real-time, comprehensive data on equipment conditions.

Modern equipment inspection involves using analog and digital models to gain insight into equipment status and operation. For example, dials, gages, graphs, and 2D or 3D illustrations are often used to illustrate equipment data. However, these inspection systems require cumbersome data preparation, manual annotations, and lack real-time adaptability. Moreover, damage evaluation remains a human judgment call, leading to user-to-user variability in equipment inspection. This shortcoming can lead to safety risks, inefficient operations, and accelerated wear on equipment components, all of which affect overall operational continuity and increase costs. Furthermore, these approaches ignore the human senses of touch, hearing, taste, and smell to collect information and deliver equipment information to the user.

What is needed in the art is an equipment inspection system that can provide precise, multimodal equipment information to inspect and monitor equipment conditions. To this end, an improved anthropomorphic computing equipment inspection system is provided that is configured to provide precise equipment data collection, real-time analysis, and multimodal presentation.

### SUMMARY

Novel aspects of the present disclosure are directed to a system for inspecting equipment. The system comprises a plurality of sensors, a computing device, and a user interface. The sensors are configured to collect equipment data. The computing device is enabled with an artificial intelligence program configured to analyze collected data and generate an output. The user interface is configured to present the output to at least one user and collect user input data.

In another aspect, the present disclosure is related to a method for monitoring equipment. The method includes collecting equipment data from a plurality of sensors; analyzing data using an artificial intelligence-enabled program; creating an integrated output using an artificial intelligence-enabled program; and delivering the output to a user through a user interface.

Other aspects, embodiments, and features of the present disclosure will become apparent from the following detailed description of the present disclosure when considered together with the accompanying figures. In the figures, each identical or substantially similar component that is illustrated in various figures is represented by a single numeral or notation. For the purposes of clarity, not every component is labeled in every figure. Nor is every component of each embodiment of the present disclosure shown where illustration is not necessary to allow those of ordinary skill in the art to understand the present disclosure.

### BRIEF DESCRIPTION OF THE DRAWINGS

The novel features believed characteristic of the disclosure are set forth in the appended claims. The disclosure itself, however, as well as a preferred mode of use, further objectives, and advantages thereof, will be best understood by reference to the following detailed description of illustrative embodiments when read in conjunction with the accompanying drawings, in which:

FIG. 1 illustrates a perspective view of an embodiment of an equipment inspection system designed and constructed in accordance with the disclosed principles;

FIG. 2 illustrates a block diagram of an exemplary embodiment of an equipment inspection system;

FIG. 3 illustrates a block diagram of an exemplary embodiment of a multimodal user interface for use with an equipment inspection system;

FIG. 4 illustrates a user wearing an exemplary embodiment of a user interface device for use with an equipment inspection system;

FIG. 5 illustrates an exemplary multimodal presentation delivered to a user through a user interface in accordance with the present disclosure;

FIG. 6 is a flowchart of a process for inspecting equipment using an equipment inspection system in accordance with the present disclosure; and

FIG. 7 is a flowchart of a process for creating a multimodal presentation for presentation on a user interface.

INDEX OF REFERENCE NUMERALS AND DEFINITIONS

| Reference | Element |
|---|---|
| 100 | equipment inspection system |
| 102 | sensors |
| 103 | equipment |
| 104 | user |
| 106 | computing device |
| 108 | microphone |
| 112 | camera |
| 114 | thermal sensor |
| 116 | scanner |
| 117 | equipment sensors |
| 118 | microphone |
| 120 | camera |
| 122 | thermal sensor |
| 124 | positioning sensor |
| 126 | pressure sensor |
| 128 | equipment database |
| 200 | block diagram |
| 201 | external source |
| 202 | processor |
| 203 | communication interface |
| 204 | memory |
| 206 | user interface |
| 300 | block diagram |
| 400 | user interface |
| 402 | visualization screen |
| 404 | audio output device |
| 406 | haptic device |
| 408 | controller |
| 410 | scent projector |
| 412 | camera |
| 414 | motion sensor |
| 416 | manual input device |
| 418 | microphone |
| 500 | exemplary multimodal presentation |
| 502 | visual stimuli |
| 504 | auditory stimuli |
| 506 | tactile stimuli |
| 508 | olfactory and gustatory stimuli |
| 600 | flowchart |
| 602 | step |
| 604 | step |
| 606 | step |
| 608 | step |
| 610 | step |
| 612 | step |
| 700 | flowchart |
| 702 | step |
| 704 | step |
| 706 | step |
| 708 | step |

### DETAILED DESCRIPTION

For the purpose of promoting an understanding of the principles in the present disclosure, reference will now be made to the embodiments illustrated in the drawings and specific language will be used to describe the same. It will nevertheless be understood that no limitation of the scope of the present disclosure is thereby intended. Any alterations and further modifications in the described embodiments, and any further applications of the principles of the present disclosure as described herein are contemplated as would normally occur to one of ordinary skill in the art to which the present disclosure relates. Although multiple embodiments are shown and discussed in detail, it will be apparent to those skilled in the relevant art that some features that are not relevant to the present disclosure may not be shown for the sake of clarity.

The equipment inspection system disclosed herein may be used to inspect, count, and manage tangible assets, such as equipment and inventory. The equipment inspection system disclosed herein redefines industrial equipment inspection by embedding real-time artificial intelligence, human-in-the-loop feedback, and autonomous learning directly into the inspection process, while enabling continuous improvement of the models from field usage—all within a connected ecosystem of smart hardware, embedded edge computing, and intuitive mobile software.

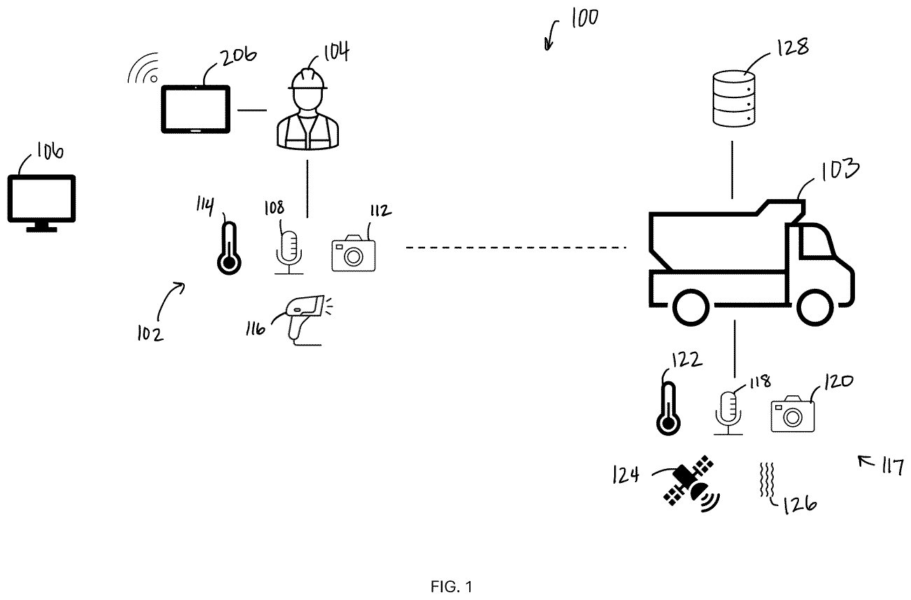

FIG. 1 illustrates a perspective view of an embodiment of an equipment inspection system 100 designed and constructed in accordance with the disclosed principles. In operation, the equipment inspection system 100 enables precise real-time data collection, analysis, and multimodal presentation.

Equipment inspection system 100 may include a plurality of sensors 102 for gathering real-time data regarding one or more pieces of equipment 103, including but not limited to equipment operation, utilization, performance, maintenance, and condition data. Equipment 103 may include tangible assets, including but not limited to vehicles such as trucks, boats, and aircrafts, heavy machinery such as drilling equipment, cranes, and excavators, energy equipment such as generators, transformers, wellheads, pipes, hoses, drilling risers, and valves, and the like. One of ordinary skill in the art will recognize that the equipment inspection system 100 may be configured to measure and evaluate equipment not specifically named herein. The plurality of sensors 102 may be configured to detect various stimuli including but not limited to light, sound, temperature, pressure, motion, chemical composition, and force. Sensors 102 may include Internet of Things (IoT) enabled sensory devices, digital sensors, and traditional analog sensors. In an embodiment, the sensors 102 may be incorporated into one or more inspection devices (not shown) that may be operated by one or more users 104, either on-site or remotely. In an embodiment, the inspection device may be a handheld device. In an embodiment, the inspection device may be handheld, wearable, or mounted on a motorized platform or drone configured to move sensors 102 about the equipment 103 to capture equipment data from multiple angles and distances. Sensors 102 may be positioned and oriented to optimize data collection. As a non-limiting example, sensors 102 may be disposed in various locations on the inspection device for distributed data collection. Additionally or alternatively, the user may capture equipment data from multiple angles and distances by moving the inspection device about the equipment 103. Additionally or alternatively, the inspection device may be configured such that the sensors 102 move about the inspection device to capture equipment data from multiple angles and distances.

As illustrated in FIG. 1, equipment inspection system 100 may include one or a plurality of microphones 108 to precisely measure sound associated with or surrounding the equipment 103. Data gathered by microphones 108 may be used to detect and record a user's vocalized observations of the equipment. As a non-limiting example, microphones 108 may be used to record the user's voice as the user 104 audibly reads the equipment serial number or describes a point of concern during the inspection. Data gathered by microphones 108 may also be used to measure equipment characteristics such as engine noise, pump cavitation, brake sounds, alarms, and single or multi-phase fluid flow. Because the industrial environment is often characterized by significant ambient noise, it may be advantageous to select microphones 108 capable of directional pickup to minimize the capture of unwanted background noise. It may also be advantageous to select different types of microphones 108 for each type of equipment 103 based on the auditory stimuli intended for capture. As non-limiting examples, microphones 108 may include shotgun directional microphones configured to capture sound from a narrow, long-distance area and cardioid microphones configured to capture sound from a wider frontal area.

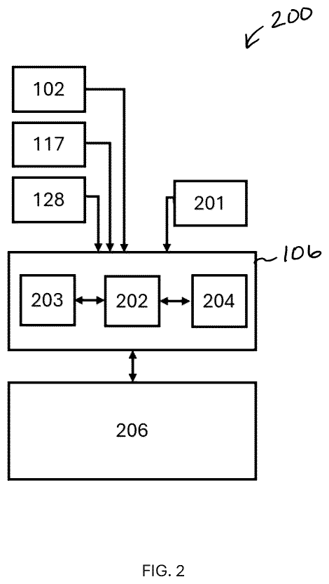

Equipment inspection system 100 may also include a plurality of cameras 112 to capture images of the equipment 103. Data gathered by cameras 112 may be used to detect, for example, defects and degradation. Data gathered by cameras 112 may also be used for computer vision and 3D imaging, discussed in greater detail in FIG. 2, to monitor visible changes over time. Many types of cameras are within the scope of the claims. As a non-limiting example, the cameras 112 may be high-resolution cameras capable of capturing 360-degree spherical images or video. Cameras 112 may be used to capture images of the same surface from multiple angles as well as large videos to enable higher certainty of anomaly detection as well as virtualization of the equipment, discussed in greater detail below. As a non-limiting example, cameras 112 may capture 30fps 1080p videos.

Equipment inspection system 100 may also include thermal sensors 114 to precisely measure heat and temperature gradients associated with the equipment 103. Data gathered by thermal sensors 114 may be used to detect, for example, operating temperature, overheating, and sudden temperature changes. Data gathered by thermal sensors 114 may also be used for computer vision, 3D imaging, and artificial intelligence fusion with additional input data, discussed in more detail in FIG. 2. Many types of thermal sensors are within the scope of the claims. As a non-limiting example, the thermal sensors 114 may be near infrared or long-wave infrared sensors and involve one or more cameras. One of ordinary skill in the art will recognize that other configurations of sensors are within the scope of the claims such as using light cameras and thermal cameras. As a non-limiting example, sensors 102 may include a scanner 116 to scan barcodes and/or device equipment tags (i.e., RFID) on the equipment 103.

Data collected by the sensors 102 may be transmitted to a computing device 106, discussed in greater detail with reference to FIG. 2. Data from additional sources may also be transmitted to the computing device 106 to enable comprehensive equipment inspection. In the non-limiting exemplary embodiment illustrated in FIG. 1, equipment 103 may equipped with a plurality of equipment sensors 117 configured to detect various stimuli including but not limited to light, sound, temperature, pressure, flow, motion, chemical composition, force, and the like. Equipment sensors 117 may be configured to detect equipment data regarding equipment operation, utilization, performance, maintenance, and condition, and the like. Equipment sensors 117 may include, for example, microphones 118, cameras 120, thermal sensors 122, positioning sensors 124, and pressure sensors 126. Equipment sensors 117 for stationary assets like pipelines may include fixed sensors including ultrasonics and distributed virtual sensors like distributed acoustic sensors, distributed temperature sensors, and distributed strain sensors utilizing a fiber optic cable and interrogator.

Data collected by equipment sensors 117 may be transmitted to computing device 106, discussed in greater detail with reference to FIG. 2. Equipment 103 may also include an equipment database 128 including stored historical and operational data for the equipment 103. Data from the equipment database 128 may be transmitted to computing device 106 to enable comprehensive equipment inspection.

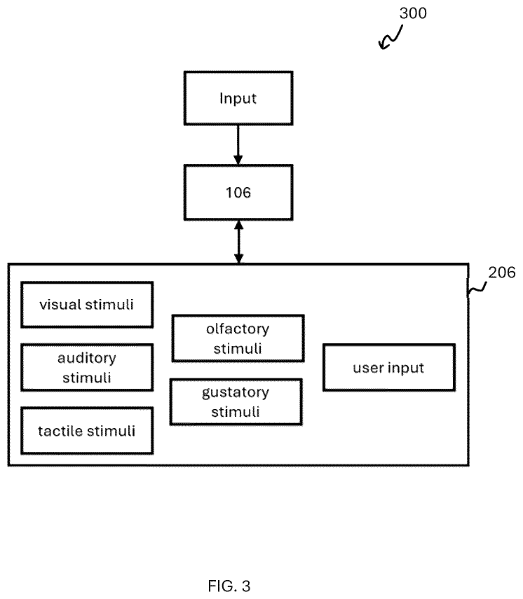

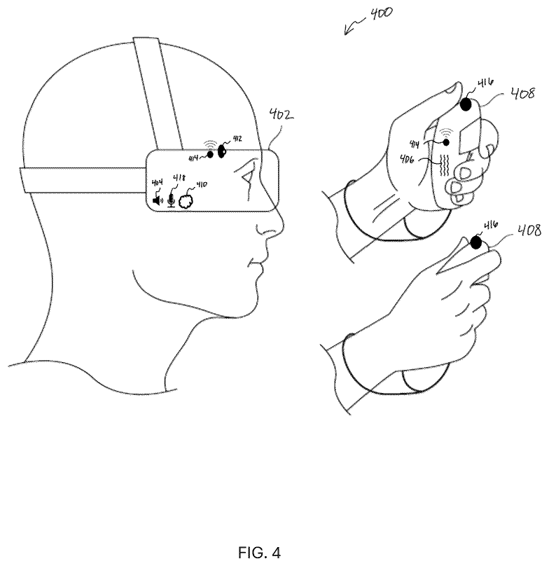

The equipment inspection system 100 may also include a user interface 206 for delivery of the output generated by the computing device 106 and collection of user input data. In the non-limiting exemplary embodiment illustrated in FIG. 1, the user interface 206 may be a cellular connected, Wi-Fi or Bluetooth enabled tablet operated by a user 104 on-site. Wi-Fi may be deployed in remote areas from a satellite communication such as Starlink. The user interface 206 is discussed in greater detail with reference to FIGS. 3 and 4 that follow.

FIG. 2 illustrates a block diagram 200 of an exemplary embodiment of an equipment inspection system 100 in accordance with the disclosed principles. In this non-limiting exemplary embodiment, data from sensors 102 and equipment sensors 117 may be transmitted to a computing device 106. Data from the equipment database 128 and external sources 201 may also be transmitted to the computing device 106 to enable comprehensive analysis of sensed and stored data. As a non-limiting example, external sources 201 may include manufacturer data systems that provide equipment data such as equipment type and age, inspection and certification records, and recall information, and weather observation stations providing data regarding weather conditions at the industrial site. User input data collected by the user interface 206, discussed in further detail in FIGS. 3 and 4, may also be transmitted to the computing device 106 for storage and analysis.

The computing device 106 may include one or more processing units 202 for processing input data, optimizing data, and generating output for delivery to the user. In one embodiment, the processing unit 202 may be artificial intelligence-enabled. Using a machine learning model, the processing unit 202 can perform various functions to evaluate input data utilizing anthropomorphic computing. As a non-limiting example, the processing unit 202 may perform multi-sensor fusion to provide a detailed analysis of equipment operations and degradation. That is, the processing unit 202 may combine input data from the various sensors and databases described herein to generate a comprehensive and dynamic representation of the equipment being monitored. In an embodiment, input data may be down sampled to reduce file memory usage, improve processing speed, and avoid overfitting.

Other functions of the processing unit 202 include but are not limited to identifying patterns and anomalies in equipment performance, simulating likely operation scenarios and outcomes, and generating quantifiable metrics regarding equipment operation, utilization, performance, maintenance, and condition. Examples of quantifiable equipment metrics include but are not limited to engine hours, idle time, fuel consumption, distance traveled, mean time between failures, tire pressure, brake system health, oil temperature, engine diagnostic codes, material integrity, flow rate, corrosion rate, leak detection, and emissions. Processing unit 202 may also perform an operational readiness assessment with anomaly and damage severity scoring or grading that augments manual judgment and standardizes decision-making. As a non-limiting example, each detected anomaly or defect may be scored based on physical attributes such as length, depth, and quantity of impact. A grading scale may auto-classify severity to reduce subjectivity associated with user grading. Processing unit 202 may also generate recommendations including but not limited to optimal solutions to identified problems and timing for future inspections and equipment replacement. Recommendations may be generated using, for example, an artificial intelligence-enabled Computerized Maintenance Management System, wherein the machine learning model is trained on Original Equipment Manufacturer manuals, equipment metadata, historical equipment inspection data, and current equipment inspection data.

The processing unit 202 may also use computer vision and 3D imaging to monitor a variety of equipment metrics, including but not limited operation, performance, defects, and degradation metrics. Processing unit 202 may automatically compare current input data to ideal equipment data retrieved from one or more databases to identify deviations. As a non-limiting example, computer-aided design data may be overlaid with input data to compute deviation heatmaps showing wear, distortion, or loss. Processing unit 202 may automatically compare current input data to historical input data from previous inspections to track equipment changes over time such as wear progression and recurrence. The processing unit 202 may also perform multimodal confidence voting to increase robustness, decrease errors rates, and provide probabilistic confidence overlays for the multimodal presentation. As a non-limiting example, input data may be processed through pre-trained computer vision models and final segmentation masks may be aggregated using confidence voting and weighted fusion.

The processing unit 202 may also analyze user input data and modify the machine learning model accordingly. The machine learning model may be tailored to the user such that the processing unit 202 may adapt to the user's individual needs, accurately predict user response, and modify outputs to reflect the user's preferences, thereby improving performance and accuracy over time for both the individual user and the collective user base. The machine learning model may include one or more reward mechanisms for tailoring functionality to the user. The machine learning model may utilize federated learning for edge connected devices where data sensitivity or limited communication methods exist to stream raw data to the cloud for processing.

The processing unit 202 may also use the artificial intelligence program to optimize data storage, processing, and delivery. As a non-limiting example, the processing unit 202 may store input data according to the metric being measured as opposed to the input source. The processing unit 202 may also ensure the processing of only high-quality data by eliminating low-quality or extraneous data. The processing unit 202 may also optimize data delivery by tuning the input data to the output modality or modalities best suited to the data range and intended use.

The processing unit 202 can also generate output for delivery to the user via the user interface 206. As a non-limiting example, the output may include a multimodal presentation that delivers equipment information to one or more human senses, discussed in greater detail in FIGS. 3-5 that follow. The output may also include customizable dashboards for the delivery of multimodal presentations to a variety of users and user interfaces 106. Output may also include, for example, equipment deviation heatmaps, interactive 3D reconstructions or a digital twin of equipment, natural language reports, and recommendations. Output can include augmented or virtual reality where identified deviations or points of interest are overlaid visually or via alternative human senses such as haptic vibrations or rumbling sounds when reviewing a minor deviation compared to severe deviation, thereby giving the user a multi-modal sense of severity which may be linked to the score assigned to each finding.

The processing unit 202 may be coupled to a memory 204 which can store input data for transmission, further processing, or later retrieval. The memory 204 may also contain an artificial intelligence-enabled program for analyzing and presenting data. The memory 204 may also include inspection supporting data, including but not limited to inspection compliance data. The memory 204 may include one or more memory components, and may include non-volatile memory, volatile memory, or some combination of the two.

The computing device 106 may also include a communications interface 203 to facilitate communication with other systems or devices. The communications interface 203 may support communications through any suitable physical or wireless communication link. For example, communications interface 203 may include a network interface card or a wired or wireless transceiver to facilitate communication over a network. The communication interface 203 can be used to facilitate communication between multiple users. For example, the communications interface 203 may provide for operations (i.e., field operator, engineer, manager etc.) communication and communication between multiple industrial sites. If local Wi-Fi is used for device communication, it may be deployed in remote areas using a satellite communication such as Starlink. The communications interface 203 like Wi-Fi or Bluetooth may also facilitate communication between a user and the computing device 106. For example, the communications interface 203 may include a speech to text human machine interface, allowing users to provide input to the computing device 106 by speaking commands or providing equipment data. The communications interface 203 may also be enabled with an artificial intelligence-enabled large language model or more specialized small language model. In an embodiment, the language model may allow the user to access certification criteria, operational data in real-time or historical, original equipment manuals, engineering bulletins, prior inspection data, and other content relevant to the equipment being inspected. While the computing device 106 may include a communications interface 203, it will be understood by one of ordinary skill in the art that the equipment inspection system 100 may operate entirely offline. That is, the equipment inspection system 100 may capture, analyze, and present equipment data without communication with other systems or devices to support field work in low-connectivity areas and enable remote use. Equipment data may be subsequently synchronized via the communications interface 203.

The computing device 106 may also include a variety of additional features not illustrated in FIG. 2. For example, the computing device 106 may include data security measures like end-to-end encryption. In an embodiment, all equipment inspection data (video, metadata, results, feedback) may be hashed, timestamped, and stored on secured end-to-end encrypted servers with hash matching. The computing device 106 may also include a data management system to optimize the storage, organization, and retrieval of data. As a non-limiting example, the data management system may allow data stored in the memory 204 to be deleted, updated, and/or retrieved according to an artificial intelligence-enabled program. The computing device 106 may also include flexible application programming interfaces (APIs) to allow communication with external software systems. As a non-limiting example, the flexible APIs may allow the computing device 106 to communicate with equipment management software to access equipment data. The computing device 106 may also utilize edge computing to process data closer to the source, reducing latency and bandwidth needs, improving data security, and enabling real-time data analysis. Edge computing may be used to perform local inference and preprocessing, including but not limited to multimodal presentation generation and 3D mapping. Edge computing may also optimize productivity and allow for movement mapping. Edge computing also enables interaction between the computing device 106 and mobile and stationary equipment information like tags (i.e., RFID) embedded in the equipment. Edge computing may be supported by federated machine learning for multi-system learning and learning package redistribution among a plurality of equipment inspection systems 100 without uploading private data to a central platform. As a non-limiting example, a computing device 106 may act as an independent node within a network of equipment inspection systems 100, generating local updates based on unique equipment data. Local updates may be securely aggregated at a central server to refine the global machine learning model without transferring sensitive or personally identifiable information to the central server. The central server may aggregate the local updates from all participating equipment inspection systems 100 through a secure federated aggregation process and then send the updated machine learning models back to individual equipment inspection systems 100.

The computing device 106 may be coupled to one or more user interfaces 206 for delivery of the output generated by the processing unit 202 and collection of user input data. User interface 206 is discussed in greater detail in FIGS. 3 and 4 that follow.

FIG. 3 illustrates a block diagram 300 of an exemplary embodiment of a user interface 206 in accordance with the disclosed principles. User interface 206 may deliver output generated by the processing unit 202 to on-site and or remote users. The user interface 206 may be configured to present equipment information to multiple human senses, including sight, sound, touch, smell, and taste. That is, the user interface 206 may deliver visual, auditory, tactile, olfactory, and gustatory stimuli to provide a multimodal presentation to the user. As a non-limiting example, the user interface 206 may deliver equipment information by presenting a 3D rendering of the equipment during operation (visual stimuli), chimes indicating mechanical failures (auditory stimuli), vibrations corresponding to equipment engine noise levels (tactile stimuli), and scents indicating the atmospheric components at the operation site (olfactory and gustatory stimuli). The user interface 206 may also direct stimuli to particular senses to enable a user to distinguish between various sources of information. As a non-limiting example, data from thermal sensors may be delivered through tactile stimuli while data from cameras may be delivered through visual stimuli. The delivery of a multimodal stimuli is discussed in greater detail in FIG. 4 that follows.

The user interface 206 may deliver the multimodal presentation to one or more human or non-human users. In one embodiment, a plurality of stimulus types may be presented in one integrated multimodal presentation. In another embodiment, the multimodal presentation may be partitioned such that each user is presented with a different stimulus or information type.

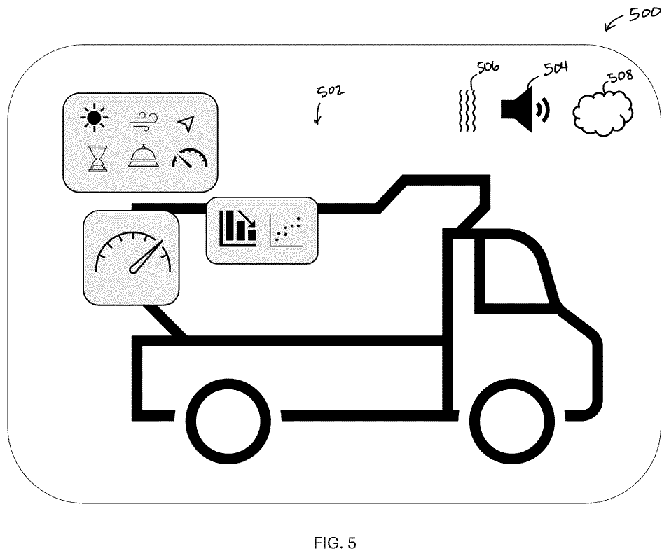

The user interface 206 may deliver the multimodal presentation in a variety of formats. In one embodiment, the user interface 206 may provide the multimodal presentation in an augmented reality environment wherein the multimodal presentation is overlaid onto the user's environment such that the user may remain aware of his surroundings. In an embodiment, the user interface 206 may provide the multimodal presentation in a shared immersive virtual reality environment. In an embodiment, the multimodal presentation may be provided on a conventional computer monitor, kiosk, tablet, or personal communication device. An exemplary multimodal presentation that may be delivered to a user via the user interface 206 is provided in FIG. 5.

The user interface 206 may also allow a user to interact with the multimodal presentation and collect user input data. User input data may be transmitted to the computing device 106, where it may be stored and delivered to the artificial intelligence-enabled processing unit 202 for evaluation and integration into the multimodal presentation. User input data may also be translated into actions in relation to the multimodal presentation. In a non-limiting exemplary embodiment, the user interface 206 may collect manual user input data as well as user speech and movement data. As a non-limiting example, a user may be able to edit incorrect components of the multimodal presentation. For example, a user may be able to provide human-in-the-loop feedback by highlighting and modifying other defects in real time during the inspection or remotely after the inspection. User input data may also include user confidence scoring wherein a user may rate the multimodal presentation's accuracy. This data may be used as a training signal to prioritize high-disagreement cases in retraining the machine learning model. The collection of user input data is discussed in greater detail in FIG. 4 that follows.

FIG. 4 illustrates a user with an exemplary user interface 400 in accordance with the disclosed principles. The user interface 400 may be configured to deliver a multimodal presentation to a user. The user interface 400 may include one or more visualization screens 402 to facilitate the delivery of a visual component of the multimodal presentation. The visualization screen 402 may display two-dimensional and three-dimensional visual components of the multimodal presentation. As a non-limiting example, the visualization screen 402 may display 3D reconstructions or digital twins of equipment. In the non-limiting embodiment illustrated in FIG. 4, the visualization screen 402 may be a wearable headset that covers the user's eyes for visual immersion. Additionally or alternatively, the visualization screen 402 may be provided by a conventional computer monitor or tablet. Other examples of visualization screens that can achieve the same utility are within the scope of the claims.

The user interface 400 may also include one or more audio output devices 404 to facilitate the delivery of an auditory component of the multimodal presentation. As a non-limiting example, the audio output devices 404 may deliver varying volumes of sound corresponding to operational sounds associated with the equipment. In the non-limiting embodiment depicted in FIG. 4, the audio output device 404 may be integrated into a wearable headset. Additionally or alternatively, audio output device 404 may be provided through a separate user interface 400 component. Examples include but are not limited to standalone speakers, air conduction headphones, and bone conduction headphones.

The user interface 400 may also include haptic devices 406 for the delivery of a tactile component of the multimodal presentation. As a non-limiting example, the haptic devices 406 may deliver varying vibration intensities corresponding to the intensity of flow through a tangible industrial asset, such as a pipeline. Haptic devices 406 may also deliver varying temperatures corresponding to equipment data, such as operating temperature. In the non-limiting embodiment illustrated in FIG. 4, the haptic devices 406 may be handheld controllers 408 with vibration motors, actuators, and thermal mechanisms. In another embodiment, haptic devices 406 may be haptic-enabled gloves or suits. Other examples of haptic devices that can achieve the same utility are within the scope of the claims.

The user interface 400 may also include one or more scent projectors 410 for the delivery of an olfactory component of the multimodal presentation. As a non-limiting example, the scent projector 410 may deliver a burning scent to indicate overheating. Olfactory stimuli provided by the scent projector 410 may also be used to deliver a gustatory component of the multimodal presentation. In the non-limiting embodiment illustrated in FIG. 4, scent projectors 410 may be integrated into a wearable headset. Additionally or alternatively, the scent projectors 410 may be provided through a separate user interface 400 component disposed in the user's environment.

The user interface 400 may also allow a user to interact with the multimodal presentation and provide user input data. As a non-limiting example, the user interface 400 may include cameras 412 and motion sensors 414 to collect data regarding the user's movements and interactions. In the non-limiting exemplary embodiment illustrated in FIG. 4, cameras 412 and motion sensors 414 may be integrated into a wearable headset. The controllers 408 may also include motion sensors 414 to detect and track a user's movements.

The user interface 400 may also include manual input devices 416 to collect input data from the user. In the non-limiting exemplary embodiment illustrated in FIG. 4, manual input devices 416 may be buttons on the controllers 408. In an alternative embodiment, manual input devices 416 may be provided through a separate user interface 400 component. Examples include but are not limited to keyboard and mouse interfaces, trackpads, game controllers, and touch-enabled screens.

The user interface 400 may also include microphones 418 to collect the user's auditory input. In the non-limiting exemplary embodiment illustrated in FIG. 4, microphones 418 may be integrated into a wearable headset. In an embodiment, microphones 418 may be standalone or integrated into another component of the user interface 400. Many other embodiments of user interfaces 400 that can achieve the same utility are within the scope of the claims. For example, in one non-limiting exemplary embodiment, each component of the user interface 400 may be provided through a user's personal communication device.

FIG. 5 is an exemplary multimodal presentation 500 that may be delivered to a user in accordance with the disclosed principles. As previously discussed, the multimodal presentation 500 may be delivered in a variety of environments, including but not limited to an augmented reality environment, immersive virtual reality environment, or on a conventional computer monitor or personal communication device. In the non-limiting exemplary multimodal presentation 500 depicted in FIG. 5, the user may be presented with visual stimuli 502 such as 3D models of the equipment, side-by-side progressions of wear or resolution of previous defects, operation simulations, dials, and warning symbols. Visual stimuli 502 may also include deviation severity grading and multisensory deviation heatmaps illustrating wear, distortion, or loss of equipment components. The user may also be presented with auditory stimuli 504 such as chimes, engine noise, and environmental simulation and tactile stimuli 506 such as vibrations and haptics. The user may also be presented with olfactory and gustatory stimuli 508 such as scents corresponding to equipment and operation data. The multimodal presentation may also include stimuli corresponding to equipment inspection and maintenance recommendations, including but not limited to next inspection date, predicted failure risk, and lifecycle expectancy. The multimodal presentation may also include visual and audio auto-generated natural language reports summarizing findings and recommendations in human-readable format. As a non-limiting example, the multimodal presentation may include a report stating, “A damaged drill pipe thread was detected at 37° counter-clockwise from the left edge of the serial number marking on the 5^{th} thread from the seal face. Heavy pitting and light corrosion noted. Damage length: 3.2 cm. Suggested action: Replace pipe joint.”. As previously mentioned, the user may interact with the multimodal presentation 500 and provide input. Data corresponding to the user's inputs may be collected, stored, and evaluated to modify data collection, analysis, and delivery.

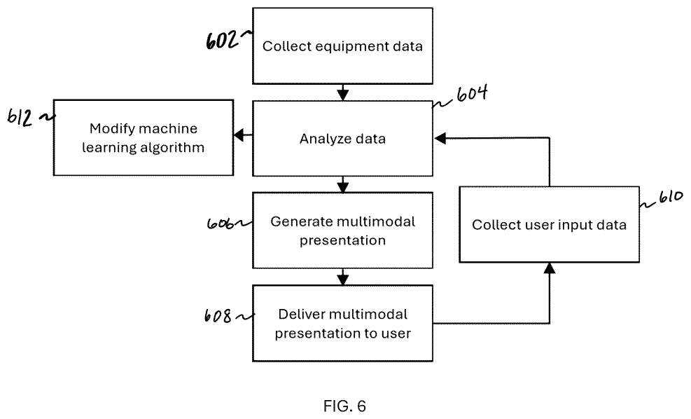

FIG. 6 is a flowchart of a process for inspecting and monitoring physical assets using an equipment inspection system 100 in accordance with the disclosed principles. The steps of flowchart 600 may be implemented by an inspection system, such as the equipment inspection system 100 exemplified and disclosed herein. In one or more embodiments, one or more of the steps may be omitted, repeated, and/or performed in a different order. Accordingly, the specific arrangement of steps shown in FIG. 6 should not be construed as limiting the scope of the embodiments.

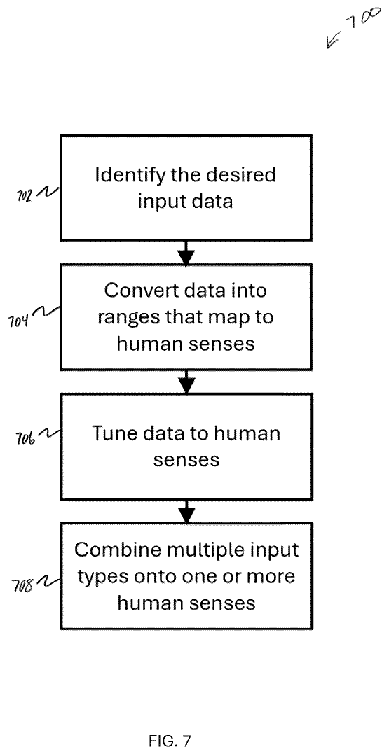

Flowchart 600 begins at step 602 by collecting equipment data. Equipment data may be collected from sensors incorporated into an inspection device, sensors embedded in the equipment, data retrieved from a database, user input, and data from external sources. In step 604, equipment data is analyzed by a computing device. The computing device may be enabled with an artificial-intelligence program for data analysis, data optimization, and output generation. As previously discussed, the computing device may utilize edge computing supported by federated machine learning to generate local updates and securely aggregate local updates at a central server without transferring sensitive information to the central server. In step 606, the computing device generates a multimodal presentation wherein input data is synthesized to create a comprehensive, integrated output. As previously discussed, the multimodal presentation may be generated on-site and remotely. The process of generating a multimodal presentation is discussed in greater detail in FIG. 7 that follows. In step 608, the multimodal presentation is delivered to the user through a user interface. As previously discussed, the multimodal presentation may be delivered to both on-site and remote users. The multimodal presentation may include the delivery of visual, auditory, tactile, olfactory, and gustatory stimuli and may be delivered in a variety of formats. In step 610, user input data is collected via the user interface and delivered to the processing unit for analysis. User input data may be translated into actions in relation to the multimodal presentation. In step 612, user input data may also be used to modify the machine learning algorithm, which may alter data collection, analysis, and delivery to improve performance and accuracy over time. The machine learning algorithm may also be modified by updates from a central server.

FIG. 7 is a flowchart of a process for generating a multimodal presentation for presentation through the user interface 206. The steps of flowchart 700 may be implemented by a computing device, such as the computing device 106 exemplified and disclosed herein. In one or more embodiments, one or more of the steps may be omitted, repeated, and/or performed in a different order. Accordingly, the specific arrangement of steps shown in FIG. 7 should not be construed as limiting the scope of the embodiments.

Flowchart 700 begins at step 702 by identifying the desired input data. As previously discussed, a large variety of data is collected from sensors, stored data, external sources, and user input. In step 702, the computing device sorts and filters input data to isolate relevant data from background data. In step 704, data is converted into ranges that map to human senses. As previously discussed, the multimodal presentation may include the delivery of visual, auditory, tactile, olfactory, and gustatory stimuli. Accordingly, data must be converted into stimuli that can be interpreted by various human senses such as sight and touch. In step 706, the input data is tuned to certain human senses. That is, input data may be adjusted to the output modality or modalities best suited to the data range and intended use. In step 708, multiple input types are combined onto one or more senses. Step 708 provides for the integration of all collected equipment data, as well as user inputs, to create a comprehensive, real-time multimodal presentation for delivery to the user.

While this disclosure has been particularly shown and described with reference to preferred embodiments, it will be understood by those skilled in the pertinent field of art that various changes in form and detail may be made therein without departing from the spirit and scope of the present disclosure. The inventors expect skilled artisans to employ such variations as appropriate, and the inventors intend the present disclosure to be practiced otherwise than as specifically described herein. Accordingly, this disclosure includes all modifications and equivalents of the subject matter recited in the claims appended hereto, as permitted by applicable law. Moreover, any combination of the above-described elements in all possible variations thereof is encompassed by the disclosure unless otherwise indicated herein or otherwise clearly contradicted by context.

Also, while various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the present disclosure set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

Moreover, the Abstract is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the claims reflect, inventive subject matter lies in less than all features of a single disclosed embodiment. Thus, the following claims are hereby incorporated into the Detailed Description, with each claim standing on its own as a separate embodiment.

Any and all publications, patents, and patent applications cited in this disclosure are herein incorporated by reference as if each were specifically and individually indicated to be incorporated by reference and set forth in its entirety herein.

I claim:

1. A system for monitoring equipment, comprising:
a plurality of sensors configured to collect equipment input data,
an artificial intelligence-enabled computing device configured to analyze input data and generate an output through anthropomorphic computing in real-time; and
a user interface configured to present the output to at least one user.

2. The system of claim 1, wherein the sensors are configured to detect one or more of light, sound, temperature, pressure, motion, chemical composition, and force.

3. The system of claim 1, wherein the sensors are positioned and oriented to optimize localized, remote, and distributed sensing and data collection.

4. The system of claim 1, wherein the sensors comprise one or more of cameras, microphones, thermal sensors, pressure sensors, and positioning sensors.

5. The system of claim 1, wherein input data further comprises data from databases and external sources.

6. The system of claim 1, wherein the computing device is further configured to use computer vision, 3D imaging, and multi-sensor fusion to monitor equipment conditions.

7. The system of claim 1, wherein the computing device comprises:
a memory storing input data and artificial intelligence programming,
a processing unit communicatively coupled to the memory and a communications interface, and wherein:
the processing unit is configured to process input data, optimize data storage, processing, and delivery, and generate an output using the artificial intelligence programming, and
the communications interface is configured to facilitate communication with other systems or devices.

8. The system of claim 1, wherein the computing device utilizes edge computing.

9. The system of claim 8, wherein edge computing is supported with cybersecurity features, edge processing, or federated machine learning.

10. The system of claim 1, wherein the computing device optimizes data delivery by tuning input data to the output modality or modalities best suited to the data range and intended use.

11. The system of claim 1, wherein the output is a multimodal presentation including visual, auditory, tactile, olfactory, and gustatory stimuli.

12. The system of claim 11, wherein the multimodal presentation is delivered through one of an augmented reality environment, a virtual reality environment, or conventional monitor, tablet, or personal communication device.

13. The system of claim 1, wherein the user interface is configured to deliver visual, auditory, tactile, olfactory and gustatory stimuli.

14. The system of claim 1, wherein the user interface is further configured to collect user input data.

15. The system of claim 14, wherein the computing device is further configured to:
analyze user input data;
modify artificial intelligence computing algorithms according to user input data;
alter input data collection based on user input data;
generate a predictive model for predicting user responses; and
generate tailored outputs to reflect user preferences.

16. The system of claim 1, wherein the user interface is a virtual reality appliance having one or more of a visualization screen, audio output, scent projectors, camera, microphones, motion sensors, and haptics.

17. A method for inspecting equipment, comprising:
collecting equipment data from a plurality of sensors, databases, and external sources;
analyzing data in real-time using an artificial intelligence-enabled program;
generating an integrated, real-time output using an artificial intelligence-enabled program;
delivering the output to a user through a user interface; and
collecting user input data through the user interface.

18. The method of claim 17, wherein generating an integrated output comprises:
identifying the desired input data;
converting data into ranges that map to human senses;
tuning input data to particular human senses; and
combining multiple input types onto one or more senses to create a comprehensive, multimodal presentation for delivery to the user.

19. The method of claim 17, wherein the integrated output is a multimodal presentation including visual, auditory, tactile, olfactory, and gustatory stimuli.

20. The method of claim 17, further comprising transmitting user input data to the artificial intelligence-enabled program for evaluation and integration into the multimodal presentation.
